(19) United States
(12) Patent Application Publication
(10) Pub. No.: US 2013/0135091 A1
(43) Pub. Date: May 30, 2013

(54) INDICATOR SYSTEM FOR AUTOMOTIVE VEHICLE

(71) Applicant: Richard Booth Platt, Grosse Pointe Farms, MI (US)

(72) Inventor: Richard Booth Platt, Grosse Pointe Farms, MI (US)

(21) Appl. No.: 13/305,972

(22) Filed: Nov. 29, 2011

(51) Int. Cl. B60Q 1/00

(52) U.S. Cl. 340/439

(57) ABSTRACT

A remote indicator for an automotive vehicle includes a sensor unit for determining the value of at least one vehicle operating parameter and for generating a wireless signal corresponding to the sensed value. After wireless transmission to a receiver, an indication of the signal is displayed to an occupant of the vehicle.

### TECHNICAL FIELD

The present disclosure relates to a parameter sensing and operator display/alert system for use with an automotive vehicle.

### BACKGROUND

Drivers of high performance automobiles frequently find it advantageous to perform manual control functions, such as transmission gear selection, in accord with engine operating parameters such as engine speed. As powerplants, including underhood wiring and plumbing, have become more complex, it has grown increasingly more difficult to provide the wiring and other utilities needed to accommodate aftermarket sensing devices intended to alert the driver of the desirability, if not the necessity, of shifting the transmission or taking other action. Moreover, commonly available sensing devices have not generally evolved to accommodate the powertrain complexity extant today. It would be desirable to provide an indicator system which is both flexible in terms of alerting capability, and compatible with power adders and multiple powertrain operating modes.

### SUMMARY

According to an aspect of the present invention, a remote indicator for an automotive vehicle includes a sensor unit determining the value of at least one vehicle prime mover operating parameter and generating a wireless signal corresponding to the sensed value, and a receiver receiving the signal wirelessly and displaying an indication of the signal to a vehicle occupant.

As used herein, the term “prime mover” means a power source such as an engine, motor, or fuel cell/motor combination, and an associated transmission, or yet other types of devices for converting chemical energy into mechanical energy.

According to another aspect of the present invention, in a preferred embodiment the sensor unit determines the operating speed of a vehicle's engine and wirelessly transmits a shift signal when the engine has reached a predetermined speed at which a vehicle transmission should be shifted to another gear by the vehicle's operator. The receiver displays a visible, audible, or haptic indication of the shift signal.

According to yet another aspect of the present invention, the value of a predetermined engine speed which triggers the operator display may be dependent upon the operational state of a power adder applied to the vehicle's engine. The power adder may be either a nitrous oxide system, a turbocharging system, a supercharging system, or other type of device which temporarily increases engine output.

According to another aspect of the present invention, a method for providing a vehicle occupant with task-related information concerning operation of a vehicle prime mover includes the steps of sensing at least one prime mover operating parameter using a sensor unit located within the vehicle in proximity to the prime mover, and generating a parametric signal corresponding to the sensed value of the operating parameter. Then, the parametric signal is transmitted wirelessly to a receiver located remotely from the sensor unit. The receiver presents an indication of the value of the parametric signal to an operator of the vehicle.

It is an advantage of the present indicator system that a variety of vehicle operating parameters may be sensed and alerts presented to a vehicle driver without the need for wiring extending between the source of the operating parameter, such as a prime mover, and the vehicle's passenger compartment. The present indicator system is therefore ideally suited for application in the automotive aftermarket.

It is another advantage of the present indicator system that the system may be selectively adjusted to trigger different shift signal ranges, with the engine speeds being dependent upon an operational state of an engine, such as whether a power adder has been activated.

It is another advantage of the present indicator system that haptics capability renders the system more useful in noisy and light-disrupted environments.

Other advantages, as well as features of the present invention, will become apparent to the reader of this specification.

### BRIEF DESCRIPTION OF THE DRAWINGS

FIG. 1 is a schematic representation of a motor vehicle having a remote indicating system according to an aspect of the present invention.

FIG. 2 illustrates a wireless receiver for displaying an indication of a parametric signal or alert to a vehicle occupant according to an aspect of the present invention.

FIG. 3 is a block diagram of a sensor unit employing a microprocessor controller according to an aspect of the present invention.

FIG. 4 illustrates a haptics bracelet employing vibration to alert a vehicle operator according to another aspect of the present invention.

FIG. 5 is a flow diagram of a remote sensing and communication method according to an aspect of the present invention.

### DETAILED DESCRIPTION

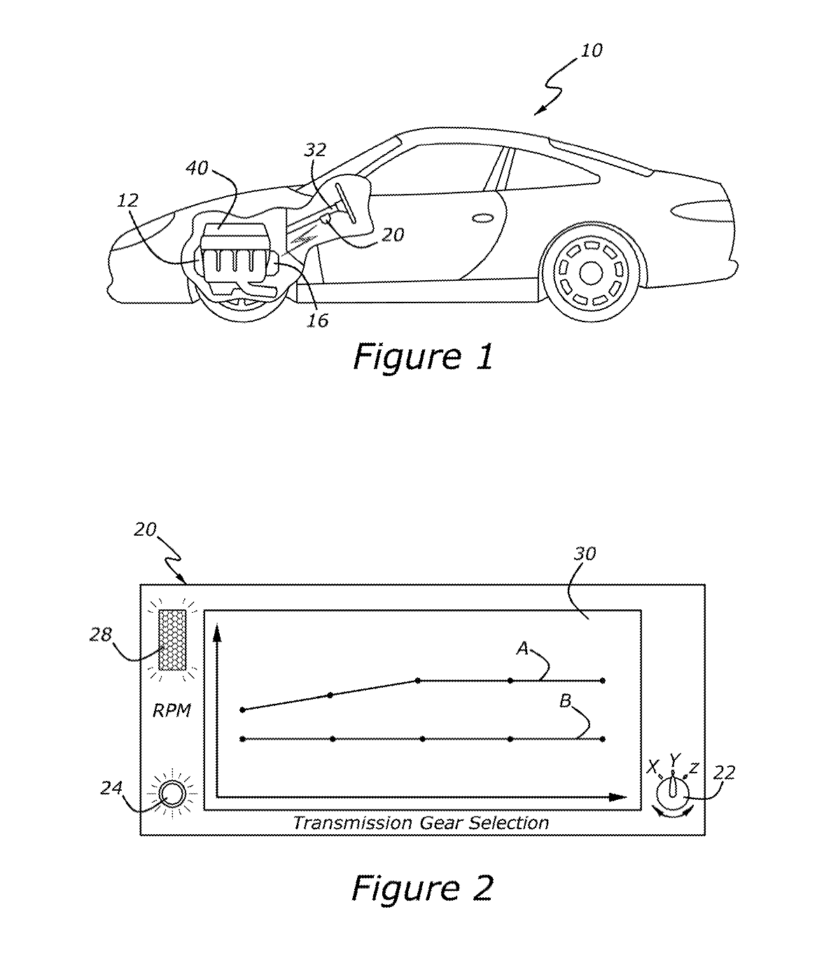

As shown in FIG. 1, an automotive vehicle, 10, is equipped with a prime mover, 12. The prime mover may be either an internal combustion engine, or other type of heat engine, or an electro-drive or fuel cell powerplant. Prime mover 12 may be equipped optionally with a power adder, 40, which, in the case of an internal combustion engine could be a nitrous oxide system, or a supercharger, or a turbocharger, or any other combination of these and other devices employed to temporarily change engine output, usually by increasing output.

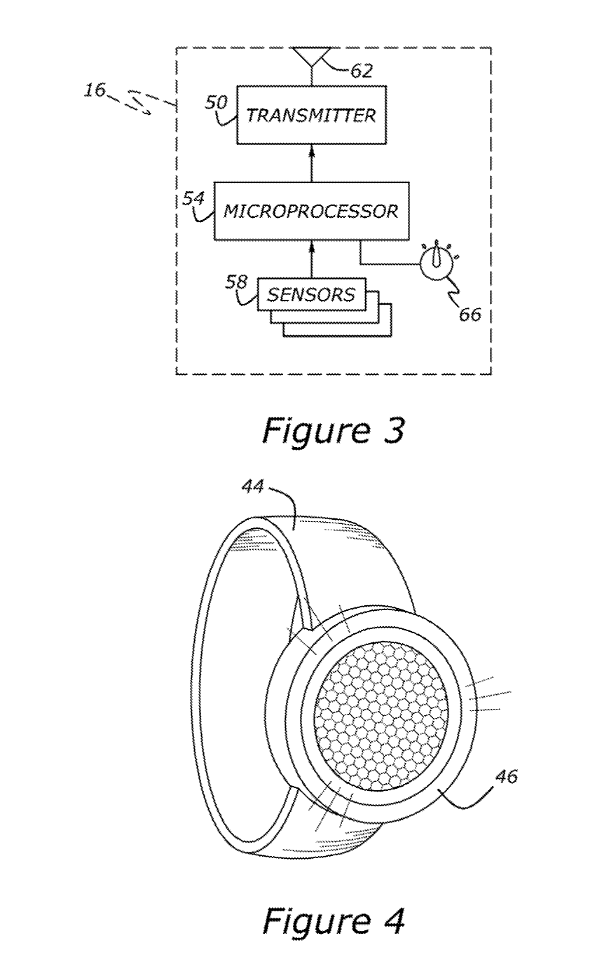

Prime mover 12 is also equipped with a sensor unit, 16, which determines the value of at least one vehicle or engine operating parameter, such as engine speed and transmission gear. Sensor unit 16 generates a wireless signal corresponding to the sensed value of the operating parameter. FIG. 3 shows details of sensor unit 16, which preferably includes one or more sensors, 58, which monitor various parameters such as engine speed, transmission gear, and power adder operational state or mode. In other words, in the case of a power adder, sensors 58 detect whether a supercharger, or nitrous oxide, or turbocharger boost is operational. Microprocessor 54 commands RF transmitter 50 to send appropriate signals using antenna 62. Sensor unit 16 may also be equipped with a mode selector, 66, which is manually positionable to accommodate several states of engine tune or parameter selections. Thus, the sensed parameter could be engine speed, transmission gear, various temperatures, engine torque, or other values.

Wireless signals from sensor unit 16 are received by a receiver, which is shown generally at 20 in FIG. 1. Receiver 20 may be either a visual display device, or a noise emitting device, or even a haptics device which sets up a vibration within steering column 32, or any other part of the vehicle, to alert the vehicle's driver that an action, such as shifting of the vehicle's transmission, should be undertaken. Those skilled in the art will appreciate in view of this disclosure that receiver 20 could employ multiple display modes including lights, sound, and haptics modes.

FIG. 2 shows an embodiment of receiver 20 with an audio horn 28, an indicator lamp, 24, and a mode selector, 22. Receiver 20 further includes a display, 30 showing two traces, A and B, corresponding to programmed transmission shift points which are manually selectable by mode selector 22. For an automatic transmission equipped vehicle; traces A and B may correspond to points at which the transmission shifts itself, as opposed to manual shifting. In either event, traces A and B show the instantaneous gear position, as well as the shift points. Trace A is more aggressive because it includes shift points at higher engine speed and a positive slope, whereas trace B shows shift points at generally the same engine speed. This is all changeable according to the position of selector 22.

FIG. 4 shows an optional bracelet, 44, which is equipped with a receiver and haptics actuator, 46. The actuator vibrates when sensor unit 16 sends a transmission shift command or other signal.

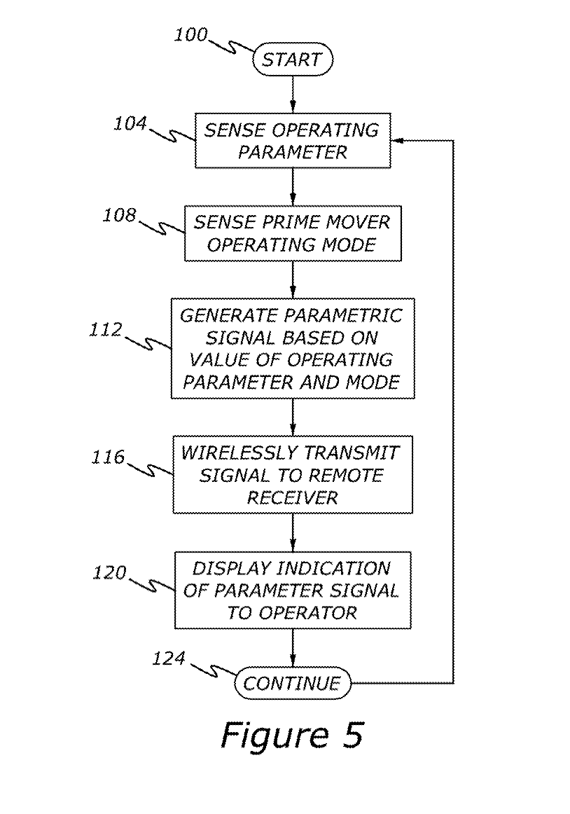

FIG. 5 illustrates a method according to the present invention. The routine starts at block 100 and moves to block 104, wherein sensors 58 measure one or more vehicle or engine operating parameters. Then, at block 108, microprocessor 54 of sensor unit 16 determines the operating mode of the prime mover by sensing parameters such as nitrous solenoid valve position or turbocharger or supercharger boost. Of course, this determination is accomplished with the aid of sensors 58. At block 112, microprocessor 54 generates a parametric signal having a value based upon the value of at least one sensed operating parameter, such as engine speed and transmission gear, and the previously determined operating state or mode, such as operation with nitrous oxide enrichment. At block 116, microprocessor 54 transmits the signal by giving RF transmitter 50 the command to send the signal through antenna 62. Finally, at block 120 receiver 20 displays an indication of the parametric signal to a vehicle operator or other occupant. The routine continues at block 124 during normal operation of the vehicle.

It should be understood that the foregoing description and the embodiments thereof are merely illustrative of many possible implementations of the present invention and are not intended to be exhaustive.

1. A remote indicator for an automotive vehicle, comprising:
a sensor unit for determining the value of at least one vehicle prime mover operating parameter and for generating a wireless signal corresponding to the sensed value; and
a receiver for receiving said signal wirelessly and for displaying an indication of said signal to a vehicle occupant.

2. The remote indicator according to claim 1, wherein said sensor unit determines the operating speed of a prime mover engine and wirelessly sends to said receiver a shift signal when the engine has reached a predetermined speed at which an associated transmission should be shifted by a vehicle operator to another gear.

3. The remote indicator according to claim 2, wherein said receiver displays a visible indication of said shift signal.

4. The remote indicator according to claim 2, wherein the value of said predetermined engine speed is dependent upon the operational state of a power adder applied to the engine.

5. The remote indicator according to claim 4, wherein the power adder comprises a nitrous oxide system.

6. The remote indicator according to claim 4, wherein the power adder comprises a turbocharging system.

7. The remote indicator according to claim 4, wherein the power adder comprises a supercharging system.

8. The remote indicator according to claim 1, wherein said sensor unit is mounted within an engine compartment of a vehicle, and said receiver is carried within a passenger compartment of the vehicle.

9. The remote indicator according to claim 1, wherein said sensor unit is mounted within an engine compartment of a vehicle, and said receiver is carried external to the engine compartment.

10. The remote indicator according to claim 2, wherein said receiver generates a haptic indication of said shift signal.

11. A remote shift indicating system for an automotive vehicle, comprising:
a sensor unit for determining the rotational speed of a vehicle's engine, with said sensor unit generating and wirelessly transmitting a shift signal if the sensed value of engine speed is within a range of predetermined, user-selected values; and
a receiver for receiving said shift signal and for displaying an indication of said signal to a vehicle occupant.

12. The shift indicating system according to claim 11, wherein said receiver illuminates a light to indicate that a shift signal has been received from said sensor unit.

13. The shift indicating system according to claim 11, wherein a plurality of engine speed ranges, correlated with an engine operational state, is used to trigger generation and transmission of the shift signal, with the speed ranges being displayed on said receiver.

14. The shift indicating system according to claim 13, wherein the correlation with engine operational state is based upon the activation of a power adder comprising at least one of a turbocharger, a supercharger, and a nitrous oxide supply system.

15. The shift indicating system according to claim 11, wherein said receiver is incorporated within a haptics bracelet providing a vibratory mode to indicate that a shift signal has been received from said sensor unit.

16. A method for providing a vehicle occupant with task-related information concerning operation of a vehicle prime mover, comprising:
sensing at least one prime mover operating parameter, using a sensor unit located within the vehicle in proximity to the prime mover;
generating a parametric signal corresponding to the sensed value of said operating parameter;
wirelessly transmitting said parametric signal to a receiver located remotely from said sensor unit; and
displaying an indication of the value of said parametric signal to an operator of the vehicle, using said receiver.

17. The method according to claim 16, wherein said at least one prime mover operating parameter comprises the rotational speed of a prime mover, with the receiver displaying a shift indicator if the sensed rotational speed falls within a range of predetermined values.

18. The method according to claim 17, wherein said range of predetermined values is selected by said sensor unit from a plurality of ranges which are correlated with a plurality of prime mover operating modes.

19. The method according to claim 18, wherein said plurality of prime mover operating modes comprises operation with a power adder activated and operation with a power adder deactivated.

20. The method according to claim 16, wherein a parametric signal is generated as a function of not only a sensed operating parameter, but also as a function of a sensed operating mode.

21. The method according to claim 20, wherein said sensed operating mode comprises operation with a power adder.

22. The method according to claim 16, wherein the indication of the value of the parametric signal is provided by a haptics alert device which is accessible to one of more occupants of a vehicle.

23. The method according to claim 22, wherein said haptics device is incorporated within a vehicle control accessible to a driver of a vehicle.

24. The method according to claim 23, wherein said haptics device is incorporated within a steering apparatus of a vehicle.

25. The method according to claim 22, wherein said haptics device is incorporated within an alert bracelet which is wearable by an occupant of the vehicle.

26. The method according to claim 16, wherein the sensed operating parameter is manually selectable.
